(19) United States
(12) Patent Application Publication
(10) Pub. No.: US 2014/0328082 A1
(43) Pub. Date: Nov. 6, 2014

(54) LIGHTING PANEL

(71) Applicant: DESIGN LED PRODUCTS LIMITED, West Lothian (GB)

(72) Inventor: James Gourlay, West Lothian (GB)

(21) Appl. No.: 14/371,041

(22) PCT Filed: Jan. 10, 2013
(86) PCT No.: PCT/GB2013/050035

§ 371 Date: Jul. 8, 2014

(30) Foreign Application Priority Data
Jan. 10, 2012 (GB) 1200320.8

(51) Int. Cl. F21V 8/00; F21K 99/00

(52) U.S. Cl. CPC G02B 6/0073; F21K 9/52; G02B 6/0065; F21K 9/90
USPC 362/608; 362/612; 29/841

(57) ABSTRACT

A lighting panel and method of production thereof is described. The lighting panel comprises a transparent substrate (7), upon a first surface of which are mounted one or more light sources (1) is described. The lighting panel further comprises a guide layer (9) wherein the guide layer is arranged so as to encapsulate the one or more light sources upon the first surface. The one or more light sources comprise top emitting LEDs side mounted upon the first surface. In this way the described apparatus provides an optically efficient means for providing “warm white” backlighting of products that can be manufactured on a commercial scale while offering acceptable levels of reliability.

The present invention relates to the field of lighting panels. In particular, a lighting panel device with integrated top emitting light emitting diodes (LEDs) is described which has particular applications for illumination, backlighting, signage or display purposes.

It is known to deploy optical systems around LEDs so as to provide useful light sources for a range of applications. Generally, the optical systems are required to exhibit a high optical efficiency, high reliability, be easily manufactured and be easily integrated with other systems. One particular field where LEDs are deployed is within thin lighting panels which are employed for a wide variety of lighting and display applications, see for example PCT Publication No. WO 2005/101070. In the described configurations the LEDs are employed with light-guide plates to achieve the required thin panel lighting. Typically, the light-guide plate is made from an acrylic or polycarbonate transparent polymer with light extraction features incorporated therein via injection moulding or surface processing techniques. The LEDs are located at one or more edges of the light-guide plate. As a result light generated from the LEDs is trapped within the light-guide plate due to the effects of total internal reflection and thus guided towards the opposite edges of the light-guide plate. The presence of the light extraction features disturb the total internal reflection condition and so cause the light to escape from the light-guide plate in a controlled manner across the extent of the light-guide plate. The overall effect of such an arrangement is that the light-guide plate transforms a point source of light, namely the LEDs, into a diffuse area of illumination.

This simple design of light-guide device has a number of performance and manufacturing limitations. For example, if the light-guide area is large, then the light from the edge mounted LEDs must travel a relatively long average distance inside the transparent polymer, resulting in significant optical loss which impacts on the overall optical efficiency of the system.

UK patent number GB 2,438,440 B describes a “Composite Light-guiding Device” which comprises a two layer light-guide structure. This structure provides a means for embedding the LEDs within the light-guide structure at any location across the full extent of the structure and so provides a device with greater optical efficiency while enabling the simple integration of high performance optical structures onto the light-guide surface for the control of the escaping light.

LEDs are manufactured in two distinct designs—top emitting and side emitting diodes. The “top” and “side” refers to what orientation the light is emitted with respect to the electrical contacts which are considered to be on the “bottom” of the device and correspond to the surface configured to be physically attached to an associated printed circuit board i.e. top emitting LEDs emit light from a surface opposite to the “bottom” of the device while side emitting LEDs emit light from a surface substantially perpendicular to the bottom surface.

Top emitting diodes are the more commonly manufactured, and hence the more commonly available, of the two LED configurations. An example of a top emitting LED, as generally depicted by reference numeral 1, is presented in FIG. 1. The package 2 of the top emitting LED 1 is approximately cuboid shaped having a typical size of 0.5 mm to 3 mm. Electrical contacts 3 on the package 2 are on the opposite side from a light emitting aperture or area 4 and are typically made from gold or tin. The package 2 is generally formed from a plastic or ceramic material and may further comprise a clear lens over the light emitting area 4. When mounted on a planar printed circuit board (PCB), the generated light is emitted from the light emitting area 4 in a normal direction to the plane of the PCB. Typically for white light output these devices exhibit powers around 1 W, a luminous efficacy of around 100 Im/W and the light is considered to be a “warm white” or a “substantially more efficient warm white” since it exhibits a colour correlated temperature (CCT) of around 3000 Kelvin.

By way of contrast, an example of a side emitting LED, as generally depicted by reference numeral 5, is presented in FIG. 2. When the side emitting diode 5 is mounted on a planar printed circuit board via the electrical contacts 3, the generated light is emitted from the light emitting area 4 in a direction substantially parallel to the plane of the printed circuit board. Typically for white light output, these devices exhibit powers around 100 mW, a luminous efficacy of around 50 Im/W and the light is considered to be a “cold white” since it exhibits a colour correlated temperature (CCT) of around 7000 Kelvin.

In some of the above described specialist applications, such as within the lighting panels employed as backlights for mobile phone LCD displays, the surface on which the electrical tracking lie on the PCBs and the direction of the light emitted need to be substantially parallel. As a result the prior art systems have tended to employ side emitting LEDs for these applications.

However, more recently there has been an increased desire within the art to achieve “warm white” backlighting for such displays. Given the relatively inexpensive production costs for LEDs there is significant resistance within the industry to commence significant redesign of side emitting LEDs so that they can emit “warm white” light.

An alternative solution is described by the present inventor within UK patent number GB 2,438,440 B. This involves the introduction of one or more reflecting structures so as to redirect the emitted light from top emitting LEDs so as to propagate in a direction substantially parallel to the plane of the transparent base substrate on which they are mounted. In practice it has been found that employing such reflective components in conjunction with top emitting LEDs introduce not insignificant optical losses which have a detrimental impact on the overall optical efficiency of the system.

It is recognised in the present invention that considerable commercial advantage is to be gained in the provision of an optically efficient means for providing a “warm white” lighting panel. It is therefore an object of an aspect of the present invention to obviate or at least mitigate the foregoing disadvantages of the lighting panels known in the art.

In the following description the terms transparent and opaque refer to the optical properties of a component of the lighting panel at the wavelengths of the light generated by the light source employed within the apparatus.

### SUMMARY OF INVENTION

According to a first aspect of the present invention there is provided a lighting panel the lighting panel comprising a transparent substrate, upon a first surface of which are mounted one or more light sources, and a guide layer, the guide layer being arranged so as to encapsulate the one or more light sources upon the first surface, wherein the one or more light sources comprise a top emitting LEDs side mounted upon the first surface.

Most preferably the one or more top emitting LEDs emit white light.

This arrangement provides a “warm white” lighting panel that exhibits significantly higher optical efficiencies when compared with those devices known in the art. The lighting panel also offers a solution that can be manufactured on a commercial scale while providing acceptable levels of reliability.

Preferably the transparent substrate has a refractive index that is greater than or equal to the refractive index of the guide layer. In this embodiment the transparent substrate and the transparent guide layer form a composite structure that acts as a guiding media for the light generated by the encapsulated LED light sources.

Alternatively the transparent substrate has a refractive index that is less than the refractive index of the guide layer. In this embodiment the guide layer acts as a guiding media for the light generated by the encapsulated LED light sources.

The lighting panel preferably further comprises one or more scattering structures arranged so as to disrupt the effects of total internal reflection within the panel for the light generated by the encapsulated LED light sources.

Most preferably the lighting panel further comprises an electrical conducting material arranged to electrically connect the one or more side mounted, top emitting LEDs to an electrical tracking located on the first surface.

Optionally the lighting panel further comprises a circuit board wherein the electrical conducting material connects the one or more side mounted, top emitting LEDs to the electrical tracking via the circuit board. The presence of the circuit board within the presently described embodiments provides a means for enhanced dissipation of the heat generated by the LEDs and so improves the reliability of the lighting panels.

The circuit board may comprise a printed circuit board. Alternatively the circuit board may comprise a daughterboard.

According to a second aspect of the present invention there is provide a method of producing a lighting panel the method comprising:
side mounting one or more top emitting LEDs onto a first surface of a transparent substrate; and
adding a guide layer to the first surface so as to encapsulate the one or more side mounted, top emitting LEDs upon the first surface.

Preferably the one or more top emitting LEDs are side mounted onto the first surface by employing an electrical conducting material to connect the one or more top emitting LEDs to an electrical tracking located on the first surface.

Alternatively the one or more top emitting LEDs are side mounted onto the first surface by
mounting the one or more LEDs on a circuit board; and
attaching the circuit board to the first surface.

Preferably an electrical conducting material is employed to attach the circuit board to the first surface.

Optionally when the circuit board is attached to the first surface a portion of the circuit board protrudes from the guide layer.

### BRIEF DESCRIPTION OF DRAWINGS

Aspects and advantages of the present invention will become apparent upon reading the following detailed description and upon reference to the following drawings in which:

FIG. 1 presents a schematic representation of a top emitting LED;

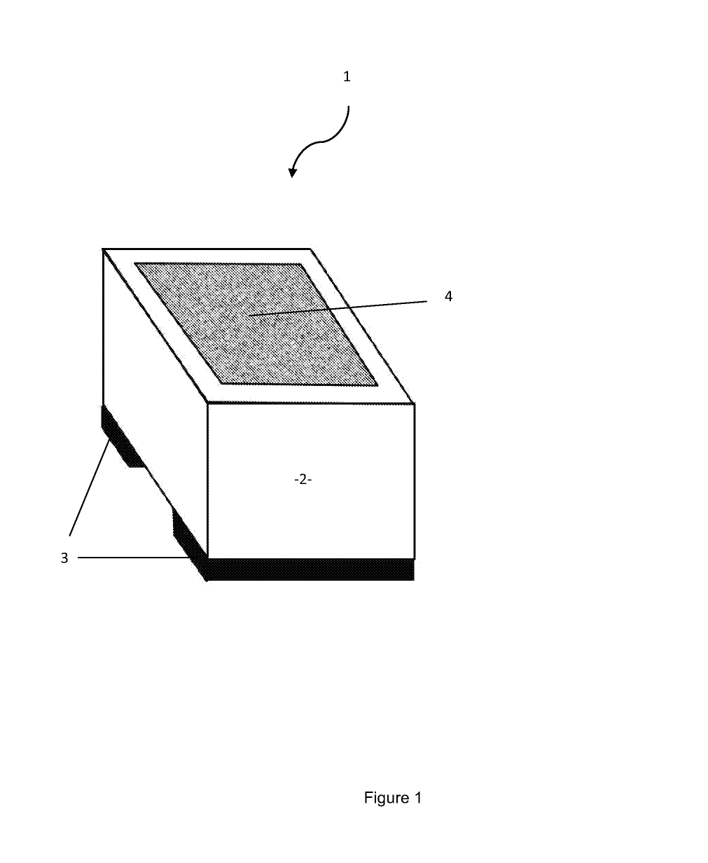

FIG. 2 presents a schematic representation of a side emitting LED;

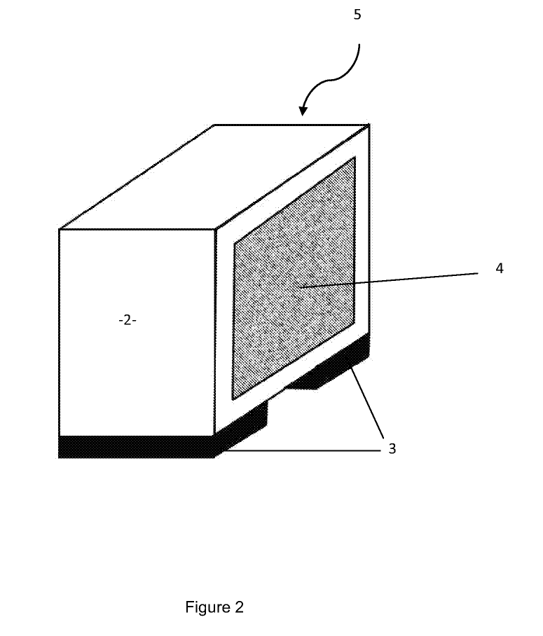

FIG. 3 presents a side view of a lighting panel in accordance with an embodiment of the present invention;

FIG. 4 presents a schematic representation of the lighting panel of FIG. 3;

FIG. 5 presents a schematic representation of a method of production of a lighting panel in accordance with an embodiment of the present invention;

FIG. 6 presents a top view of the lighting panel produced by the method of FIG. 5;

FIG. 7 presents a side view of a lighting panel in accordance with an alternative embodiment of the present invention; and

FIG. 8 presents a schematic representation of the lighting panel of FIG. 7;

FIG. 9 presents a schematic representation of a method of production of a lighting panel in accordance with an alternative embodiment of the present invention;

FIG. 10 presents a top view of the lighting panel produced by the method of FIG. 9; and

FIG. 11 presents a side view of a lighting panel in accordance with an alternative embodiment of the present invention.

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION

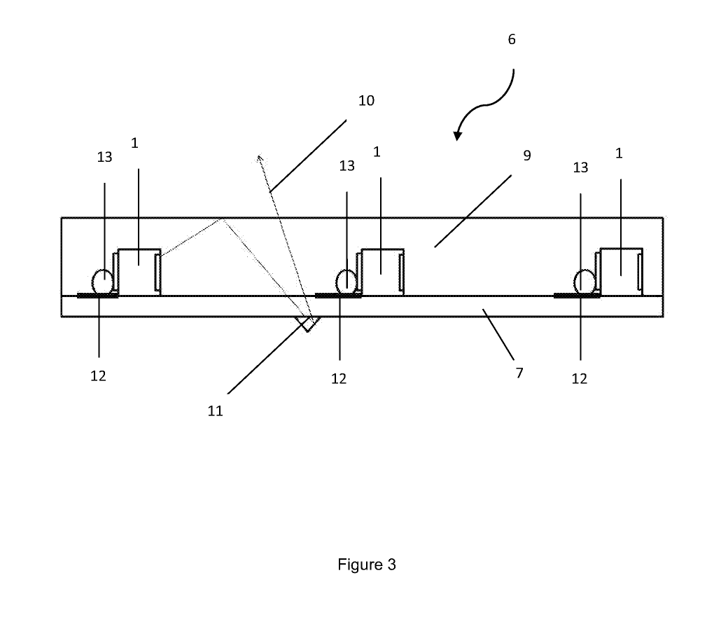

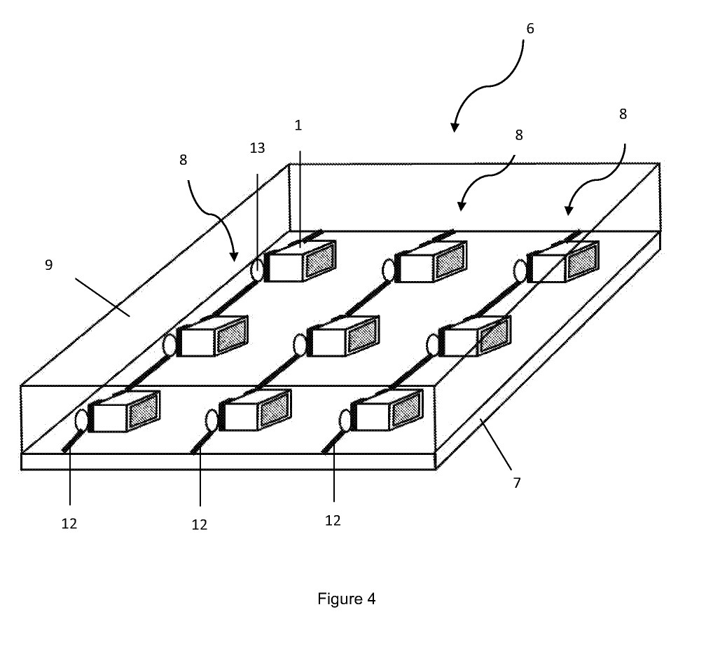

Referring to FIGS. 3 and 4, a side view and a schematic representation, respectively, of a lighting panel 6 in accordance with an embodiment of the present invention is presented. The lighting panel 6 can be seen to comprise a substrate 7 made from a transparent polymer sheet, such as polyester or polycarbonate and having a refractive index nₛ between 1.50 and 1.61.

Located on top of the substrate 7 are three, 3×1 arrays of light sources 8, further details of which are provided below.

Covering the 3×1 arrays of light sources 8, and the remaining area of the top surface of transparent substrate 7, is a guide layer 9, also formed from a transparent plastic polymer e.g. silicone, and having a refractive index n_{g} between 1.41 and 1.56. The refractive indices of the transparent substrate and the transparent guide layer 9 are selected such that they satisfy the inequality nₛ≧n_{g}. As a result, and as shown in FIG. 3, light 10 generated by the 3×1 arrays of light sources is initially coupled into the transparent guide layer 9 so as to propagate in a direction substantially parallel to a plane defined by the transparent substrate 7. Since the refractive index of the transparent substrate 7 is selected to be equal or higher than that of the transparent guide layer 9, the generated light 10 is guided within the combined structure formed by the transparent substrate 7 and the transparent guide layer 9 due to the effects of total internal reflection. Therefore, the transparent substrate 7 and the transparent guide layer 9 form a composite structure that acts as the guiding media for the light 10 generated by the encapsulated LED light sources 1.

Located on the lower surface of the transparent substrate 7 are a plurality of scattering structures 11. For ease of understanding a single pyramid style scattering structure 11 is presented. The scattering structures 11 may comprise alternative shaped structures or compositions e.g. a patterned layer of a reflecting ink. When the light 10 has propagated as far as the scattering structure 11 it interacts with this structure so disrupt or overcome the effects of total internal reflection. As a result the light 10 is redirected and so exits the device via the top surface of the transparent guide layer 9, so providing a backlighting function. It will be readily apparent to those skilled in the art that the scattering structures 11 may alternatively be located on the top surface of the transparent guide layer 9. In this embodiment the redirected light 10 will exit the device via the lower surface of the transparent substrate 7.

Each of the 3×1 arrays of light sources 8 can be seen to comprise three top emitting LEDs 1 mounted on an electrical tracking 12. Significant however, is the fact that all of the top emitting LEDs are side mounted on the electrical tracking 12 i.e. the generated “warm white” propagating from the light emitting areas 4 is now emitted in a direction substantially parallel to the plane of the transparent substrate 7. In the presently described embodiment globules of electrical conducting material 13 provides the means for electrically and mechanically connecting the side mounted top emitting LEDs to the respective electrical tracking 12. The electrically conducting material 13 comprises a silver loaded epoxy however it may alternatively comprise any other electrically conducting material that can be dispensed or printed in the desired volumes before being fixed in place e.g. by a curing process.

The above described lighting panel 6 provides a novel means for providing “warm white” illumination, backlighting, signage or displays. The apparatus employs standard top emitting LEDs 1 but does not require the employment of one or more reflecting structures so as to redirect light emitted from top emitting LEDs so as to propagate in a direction substantially parallel to the plane of the transparent substrate 7 on which they are mounted. As a result the described lighting panels 6 exhibit significantly higher optical efficiencies when compared with those devices known in the art. In addition they also offer a solution that can be manufactured on a commercial scale while offering acceptable levels of reliability.

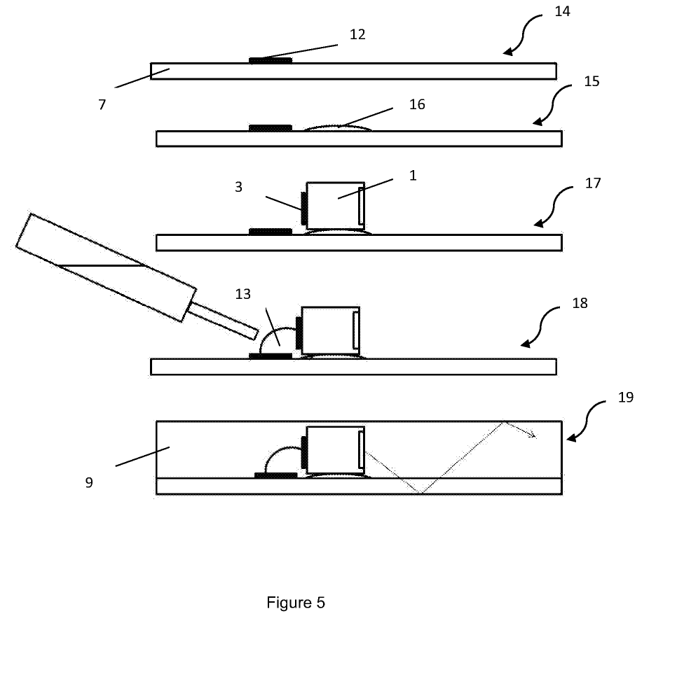

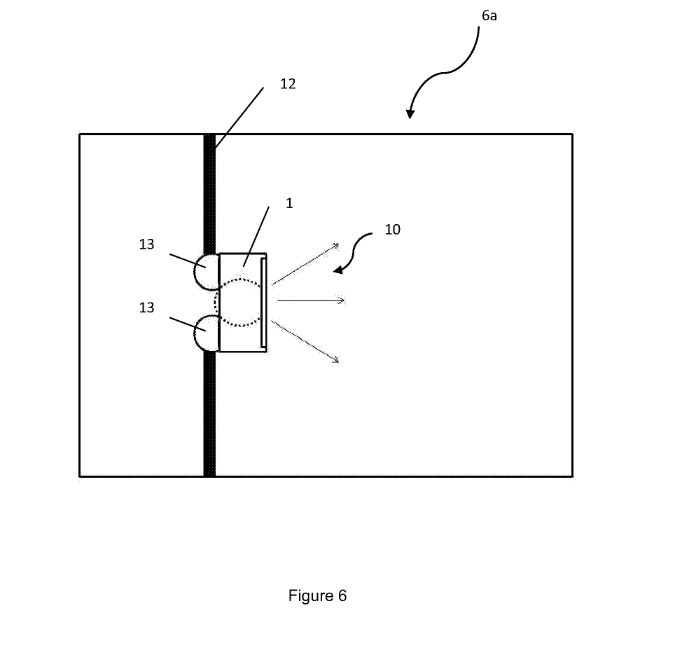

A method of producing a lighting apparatus 6a in accordance with an alternative embodiment of the present invention will now be described with reference to FIG. 5 and FIG. 6. The first step 14 involves the deployment of an electrical tracking 12 on the top surface of the transparent substrate 7. Two contact pads (not explicitly shown) are then attached to the electrical tracking 3 at the desired location for the LED 1.

The second step 15 involves depositing some adhesive 16 on the top surface of the transparent substrate 7 at the desired position for locating the LED 1.

The third step 17 involves placing the top emitting LED 1 on top of the adhesive such that it is side mounted on the electrical tracking 12 i.e. the generated “warm white” propagating from the light emitting area 4 is arranged such that it will be emitted in a direction substantially parallel to the plane of the transparent substrate 7. A pick and place, surface-mount machine may be employed to complete this stage of the process.

The fourth step 18 comprises the application of two globules of conducting material 13 onto the electrical pads in the vicinity of the electrical contacts 3 for the LED 1. Each globule 13 then connects the respective electrical pad to the LED 1. The globules of conducting material 13 are then cured or reflowed to form a solid mechanical and electrical connection between the electrical pads on the tracking 12 of the transparent substrate 7 and the contacts 3 of the LED 1, thus allowing electrical power to be delivered to the LED 1.

The final step 19 comprises the application of the transparent guide layer 9 on top of the transparent substrate 7, so as to encapsulating the LED 1. This may be achieved by applying the desired liquid polymer to the top surface of the substrate 7 by printing, stenciling or dispensing the liquid polymer. By correctly selecting the refractive indices for the transparent substrate 7 and the guide layer 9 these components form a composite structure that acts as the guiding media for the light 10 generated by the encapsulated LED 1.

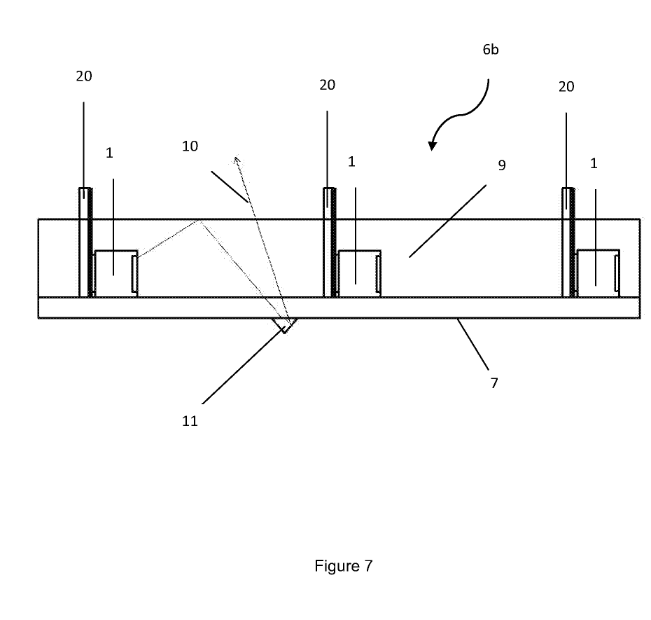

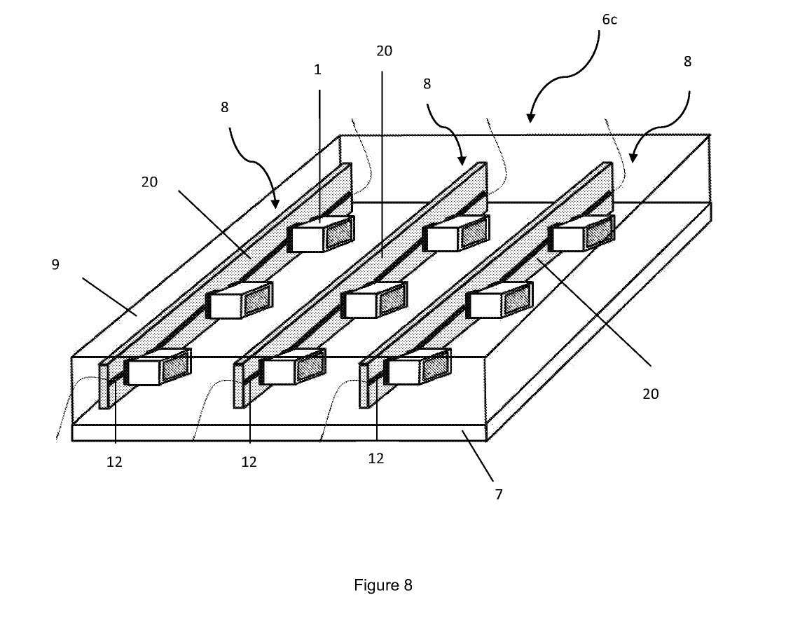

Referring to FIGS. 7 and 8, a side view and a schematic representation, respectively, of a lighting panel 6b and 6c in accordance with alternative embodiments of the present invention are presented. The lighting panels 6b and 6c can again be seen to comprise a substrate 7 made from a transparent polymer sheet, such as polyester or polycarbonate and having a refractive index nₛ between 1.50 and 1.61.

Located on top of the substrate 7 are three, 3×1 arrays of light sources 8b, further details of which are provided below.

Covering the 3×1 arrays of light sources 8, and the remaining area of the top surface of transparent substrate 7 is a guide layer 9, again formed from a transparent plastic polymer, and having a refractive index n_{g} between 1.46 and 1.56. The refractive indices of the transparent substrate 7 and the transparent guide layer 9 are again selected such that they satisfy the inequality nₛ≧n_{g} such that the transparent substrate 7 and the transparent guide layer 9 form a composite structure that acts as the guiding media for the light 10 generated by the encapsulated LED light sources 1.

Located on the lower surface of the transparent substrate 7 are a plurality of scattering structures 11.

In these embodiments, each of the 3×1 arrays of light sources 8b can again be seen to comprise three top emitting LEDs 1. However, in the presently described embodiments the LEDs 1 are initially mounted in a conventional manner onto a printed circuit board (PCB) 20. This is achieved via two contact pads (not explicitly shown) that are attached to the electrical tracking at the desired location for positioning of the LED 1. Solder reflow or conducting epoxy may be employed to mechanically and electrically connect the contacts 3 of the LED 1 to the contact pads. The PCB 20 may comprise a transparent material e.g. polyethylene terephthalate (PET) or polyimide or an opaque material e.g. FR-4 (woven glass and epoxy) or aluminium.

As can be seen from FIGS. 7 and 8 the PCBs 20 are side mounted into the top surface of the transparent substrate 7 before the guide layer 9 is cured and hardened so as to encapsulate the LEDs 1. In this way the top emitting LEDs 1 are again mounted on the substrate 7 in a side emitter configuration within the composite light-guiding structure with electrical connections to the LEDs 1 being made through the electrical tracking 12 on the substrate 7.

In FIG. 7 the PCB 20 can be seen to protrude from the top surface of the guide layer 9 while in the embodiment of FIG. 8 the PCBs 20 are fully encapsulated. In both embodiments the PCBs 20 are found to provide a means for enhanced dissipation of the heat generated by the LEDs 1, although this effect is more significant within the projected PCB 20 configuration of FIG. 7. Being able to increase the dissipation of the heat generated by the LEDs 1 has obvious benefits for the reliability of the lighting panels 6c and 6d.

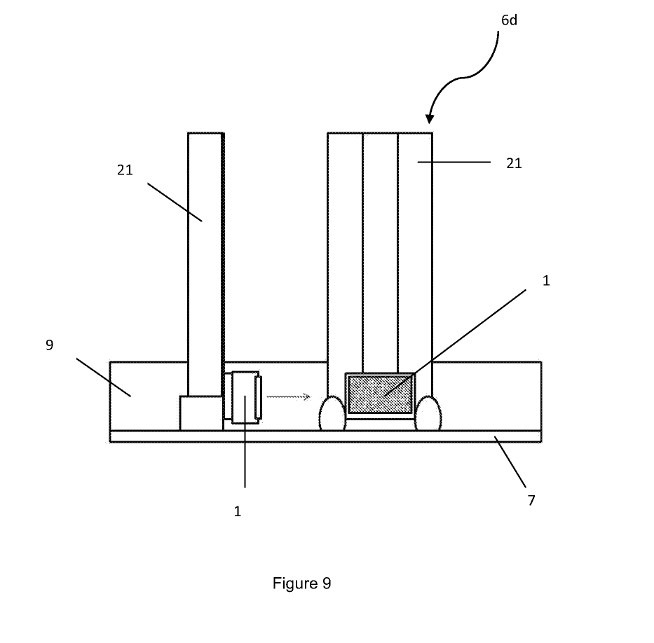

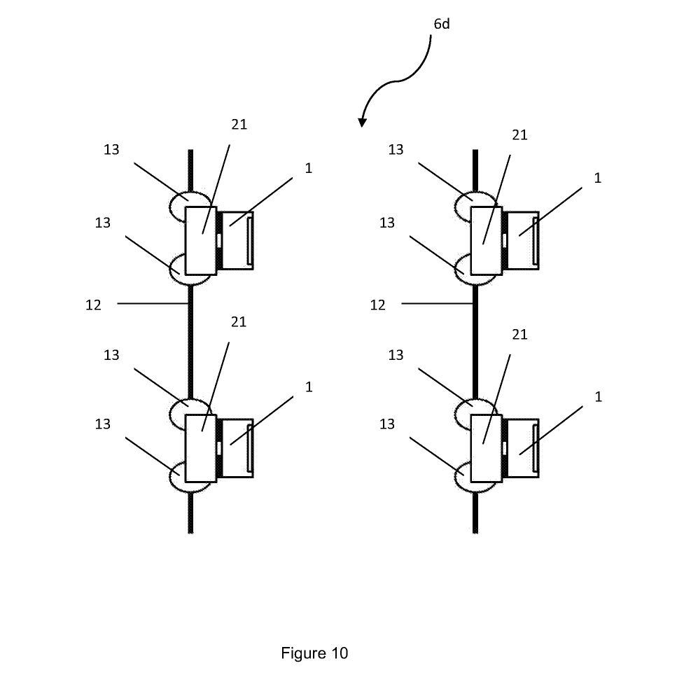

FIG. 9 presents a schematic representation of a method of production of a lighting panel 6d in accordance with an alternative embodiment of the present invention while FIG. 10 presents a top view of the lighting panel 6d produced by this method. This embodiment is similar to that described above with reference to FIGS. 7 and 8 however, instead of mounting the LED 1 on a conventional PCB 20 the LED 1 is instead mounted on a daughterboard 21. The transparent substrate 7 is also adapted such that the daughterboard 21 can be mechanically connected to the substrate 7 via plugs, sockets, pins or other similar mechanical connecting means.

The manufacture of the daughterboard 21 can be by a simple and low cost printed circuit board manufacturing method. Importantly, the daughterboard 21 is manufactured so as to have electrical pads (not explicitly shown) on the two separate surfaces, one set adapted for electrical connection to the LED 1 and the other adapted for connection to the electrical tracking 12 on the top surface of the transparent substrate 7. Solder reflow or conducting epoxy may be employed to achieve the desired electrical connections between these components.

As will be readily apparent to the skilled reader the presently described embodiment provides an alternative means for mounting the top emitting LEDs 1 on the substrate 7 in a side emitter configuration within the composite light-guiding structure with electrical connections to the LEDs 1 again being made through the electrical tracking 12 on the substrate 7.

As with the above described embodiments that employ PCBs 20 the presence of the daughterboards 21 within the presently described embodiments also provide a means for enhanced dissipation of the heat generated by the LEDs 1.

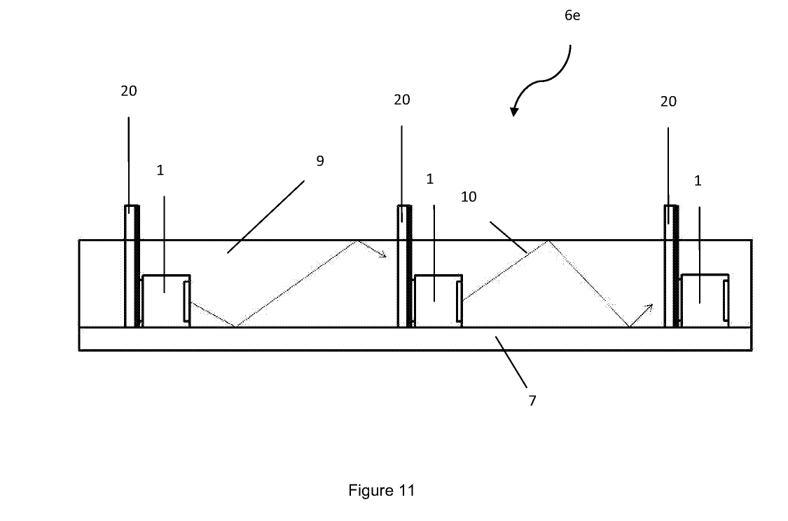

In a yet further alternative embodiment shown in FIG. 11, and generally depicted by reference numeral 6e, the relative refractive indices between the transparent substrate 7 and the guide layer 9 may be selected such that they satisfy the inequality nₛ<n_{g}. The light 10 generated by the 3×1 arrays of light sources 8 is again initially coupled into the transparent guide layer 9 so as to propagate in a direction substantially parallel to a plane defined by the transparent substrate 7. However since the refractive index of the transparent substrate 7 is selected to be less than that of the transparent guide layer 9, the generated light 10 is guided wholly within the transparent guide layer 9 due to the effects of total internal reflection. In the presently described embodiment it will be recognised by the skilled reader that the plurality of scattering structures 11 (omitted from this Figure for ease of understanding) are required to be located on the top surface of the guide layer 9. As a result the light 10 is redirected as described previously and so exits the device 6e via the lower surface of the substrate 7, so as to provide the desired backlighting function.

Although described in relation to top emitting LEDs that emit white light it will be apparent to the skilled reader that the above described embodiments may employ different coloured LEDs. This may involve employing only LEDs that emit a single colour within the lighting panel or alternatively LEDs that emit different colours so that a combination of lighting effects can be produced.

The above described embodiments provide a lighting panel suitable for providing “warm white” backlighting for a range of products e.g. mobile phone LCD displays. The lighting panels are able to employ standard top emitting LEDs and so avoid the need for significant redesign of the side emitting LEDs known in the art. Furthermore, the described embodiments do not require the employment of one or more reflective components and so exhibit significantly greater optical efficiencies when compared to those systems known in the art.

A further advantage of some of the above described embodiments is the fact that the PCD and daughterboards employed within the apparatus offer enhanced dissipation of the heat generated by the LEDs. Being able to increase the dissipation of the heat generated by the LEDs has obvious benefits for the reliability of the described lighting panels.

As a result of these combined advantages the described lighting panels offer a means for “warm white” backlighting of products that can be manufactured on a commercial scale while offering acceptable levels of reliability.

A lighting panel and method of production thereof is described. The lighting panel comprises a transparent substrate, upon a first surface of which are mounted one or more light sources is described. The lighting panel further comprises a guide layer wherein the guide layer is arranged so as to encapsulate the one or more light sources upon the first surface. The one or more light sources comprise top emitting LEDs side mounted upon the first surface. In this way the described apparatus provides an optically efficient means for providing “warm white” backlighting of products that can be manufactured on a commercial scale while offering acceptable levels of reliability.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1) A lighting panel comprising a transparent substrate, upon a first surface of which are mounted one or more light sources, and a guide layer, the guide layer being arranged to encapsulate the one or more light sources upon the first surface, wherein the one or more light sources comprise top emitting LEDs side mounted upon the first surface.

2) A lighting panel as claimed in claim 1 wherein the one or more top emitting LEDs emit white light.

3) A lighting panel as claimed in claim 1 wherein the transparent substrate has a refractive index that is greater than or equal to the refractive index of the guide layer.

4) A lighting panel as claimed in claim 1 wherein the transparent substrate has a refractive index that is less than the refractive index of the guide layer.

5) A lighting panel as claimed in claim 1 wherein the lighting panel further comprises one or more scattering structures arranged so as to disrupt the effects of total internal reflection within the panel for the light generated by the encapsulated LED light sources.

6) A lighting panel as claimed in claim 1 wherein the lighting panel further comprises an electrical conducting material arranged to electrically connect the one or more side mounted, top emitting LEDs to an electrical tracking located on the first surface.

7) A lighting panel as claimed in claim 6 wherein the lighting panel further comprises a circuit board wherein the electrical conducting material connects the one or more side mounted, top emitting LEDs to the electrical tracking via the circuit board.

8) A lighting panel as claimed in claim 7 wherein the circuit board comprises a printed circuit board.

9) A lighting panel as claimed in claim 7 wherein the circuit board comprises a daughterboard.

10) A method of producing a lighting panel the method comprising:
side mounting one or more top emitting LEDs onto a first surface of a transparent substrate; and
adding a guide layer to the first surface to encapsulate the one or more side mounted, top emitting LEDs upon the first surface.

11) A method of producing a lighting panel as claimed in claim 11 wherein the one or more top emitting LEDs are side mounted onto the first surface by employing an electrical conducting material to connect the one or more top emitting LEDs to an electrical tracking located on the first surface.

12) A method of producing a lighting panel as claimed in claim 11 wherein the one or more top emitting LEDs are side mounted onto the first surface by:
mounting the one or more LEDs on a circuit board; and
attaching the circuit board to the first surface.

13) A method of producing a lighting panel as claimed in claim 12 wherein an electrical conducting material is employed to attach the circuit board to the first surface.

14) A method of producing a lighting panel as claimed in claim 13 wherein when the circuit board is attached to the first surface a portion of the circuit board protrudes from the guide layer.

15)-20) (canceled)
